(19) United States
(12) Patent Application Publication
(10) Pub. No.: US 2025/0042120 A1
(43) Pub. Date: Feb. 6, 2025

(54) OFFSET CORE DEVICE AND A METHOD OF MAKING THE OFFSET CORE DEVICE

(71) Applicant: DEGREES OF FREEDOM LLC, VENICE, CA (US)

(72) Inventor: Brian Ignaut, El Segundo, CA (US)

(21) Appl. No.: 18/794,465

(22) Filed: Aug. 5, 2024

Related U.S. Application Data
(60) Provisional application No. 63/517,707, filed on Aug. 4, 2023.

(51) Int. Cl. B31D 5/00; D21H 27/00

(52) U.S. Cl. CPC B31D 5/0065; D21H 5/24

(57) ABSTRACT

An offset core device configured to form a high-strength truss structure, and a method for making the offset core device. The device includes a plurality of panels, each panel having a network of a first plurality of truss segments and a second plurality of truss segments, each formed along a first direction. The plurality of panels also include a first joint and a second joint formed along a second direction that is perpendicular to the first direction, and at least one cut line formed along the first direction between the first plurality of truss segments and the second plurality of truss segments. The plurality of panels are configured to deploy to a truss structure by at least one of the first plurality of truss segments pivoting at the first joint, and at least one of the second plurality of truss segments pivoting at the second joint, wherein the first joint is offset from the second joint along the first direction.

### CROSS REFERENCE TO RELATED APPLICATIONS

This application is entitled to and hereby claims priority under 35 U.S.C. § 119(e) to U.S. Provisional Patent Application No. 63/517,707, filed Aug. 4, 2023, titled “Offset Core Device And A Method of Making The Offset Core Device,” which is hereby incorporated herein in its entirety.

### FIELD OF THE DISCLOSURE

The disclosure relates to a novel offset core device and a method of making the offset core device and, more particularly, an offset core device comprising a three-dimensional truss structure and method of making the three-dimensional trust structure out of, for example, a planar material.

### SUMMARY OF THE DISCLOSURE

In a non-limiting aspect of the disclosure, an offset core device is provided that can comprise a composite core and three-dimensional (3D) truss structure. In certain non-limiting embodiments, the offset core device comprises an offset core structure that includes a composite core with a truss structure that is configured to collapse to a flat stack that is, for practical purposes, substantially two-dimensional (2D) and expand out to a high-strength 3D structure. In various embodiments, the high-strength 3D structure can be configured to withstand forces ranging from, for example, 5 lbs./in² to 50 lbs./in², or greater when a load is substantially evenly distributed across an area of the offset core device 1. Moreover, the 3D structure can be made to deploy to a fully deployed state having a size that is 100 times or greater than its size when in a fully collapsed state.

In a non-limiting embodiment, offset core device can comprise an offset core structure that includes a composite core with a truss structure that is configured to form a curve-shaped truss structure, such as, but not limited to, for example, an arc-shape, a cylindrical shape, an elliptical shape or the like. By tuning the length of the cuts and creases (though leaving the overall arrangement the same), an arbitrary curvature can be prescribed to an unfolded segment. For example, using this modification, a flat stack can be designed to unfold into a cylindrical truss.

The offset core device can comprise a collapsible/expandable 3D truss structure configured to expand from a flat stack to a 3D structure having a shape such as, for example, a 3D block, a planar structure, a curved structure, a cylindrical structure, a longitudinal structure, or a structure comprising at least two sides configured with sides separated by and interconnected with a plurality of trusses. The 3D truss structure can be configured to collapse from the 3D structure to the flat stack.

In another non-limiting aspect of the disclosure, a method is provided for making an offset core device comprising a high-strength 3D truss structure. In at least one embodiment, the method comprises making a network of parallel creases and transverse cuts on one or more sheets of material. The cuts can be non-synchronous (or asynchronous) or offset relative to adjacent cuts. The method can include forming (or attaching) a plurality of adhesive applications, including an adhesive (or sticky) application on each segment of a plurality of segments of the sheet material.

In an embodiment, the method comprises making one or more sheets of material formed with a network of parallel creases and/or transverse cuts. In that embodiment, a sheet of material can be formed with a plurality of segments, each having an adhesive application. Alternatively, each adhesive application can be affixed (or attached) to each of the plurality of segments of the sheet of material.

In an embodiment, the method comprises a corrugation-less process of making one or more sheets of material formed with a network of parallel creases and/or transverse cuts such as by using a three-dimensional (3D) printer configured to form the 3D truss structure. The 3D printer can be configured to print the complete truss structure in its fully collapsed state, including forming each segment and joint, and separation between adjacent segments and/or adjacent segment-joint combinations. The collapsed, flat structure can then be deployed to its fully deployed state, which can be one-hundred times, or greater, in size from that when it is in its collapsed state. The 3D printer can be configured with a high-strength material such as, for example, polycarbonate (PC), acrylonitrile butadiene styrene (ABS), high density poly ethylene (HDPE), metal, or the like.

In an embodiment, the offset core device comprises a high-strength three-dimensional truss structure formed out of a substantially planar sheet. In a non-limiting embodiment, the three-dimensional truss structure can be configured to be easily flattened into a substantially planar structure.

Additional features, advantages, and embodiments of the disclosure may be set forth or apparent from consideration of the following detailed description, drawings, and claims. Moreover, it is to be understood that both the foregoing summary of the disclosure and the following detailed description are exemplary and intended to provide further explanation without limiting the scope of the disclosure as claimed.

### BRIEF DESCRIPTION OF THE DRAWINGS

The accompanying drawings, which are included to provide a further understanding of the disclosure, are incorporated in and constitute a part of this specification, illustrate embodiments of the disclosure and together with the detailed description serve to explain the principles of the disclosure. No attempt is made to show structural details of the disclosure in more detail than may be necessary for a fundamental understanding of the disclosure and the various ways in which it may be practiced.

FIG. 1 shows a view of an example of a planar structure that can be used to make one or more embodiments of an offset core device, according to the principles of the disclosure.

FIG. 2 shows a perspective view of an embodiment of an offset core device in a fully collapsed configuration.

FIGS. 3 and 4 show sides view of the embodiment of the offset core device.

FIGS. 5-8 show various views of the embodiment of the offset core device in a partially deployed configuration, such as, for example, about 25% deployed.

FIGS. 9-11 show various views of the embodiment of the offset core device of in a moderately deployed configuration, such as, for example, about 50% deployed.

FIGS. 12-14 show various views of the embodiment of the offset core device of in a near-fully deployed configuration, such as, for example, about 75% deployed.

FIGS. 15 and 16 show perspective and side views, respectively, of the embodiment of the offset core device in a fully deployed configuration.

The present disclosure is further described in the detailed description and drawings that follows.

### DETAILED DESCRIPTION OF THE DISCLOSURE

The embodiments of the disclosure and the various features and advantageous details thereof are explained more fully with reference to the non-limiting embodiments and examples that are described or illustrated in the accompanying drawings and detailed in the following description. The features illustrated in the drawings are not necessarily drawn to scale, and features of one embodiment can be employed with other embodiments as the skilled artisan would recognize, even if not explicitly stated. Descriptions of well-known components and processing techniques may be omitted so as to not unnecessarily obscure the embodiments of the disclosure. The examples are intended merely to facilitate an understanding of ways in which the disclosure can be practiced and to further enable those of skill in the art to practice the embodiments of the disclosure. Accordingly, the examples and embodiments should not be construed as limiting the scope of the disclosure, which is defined solely by the appended claims and applicable law. Moreover, it is noted that like reference numerals represent similar parts throughout the several views of the drawings.

The disclosure provides a method of making various embodiments of an offset core device having a high-strength three-dimensional truss structure out of one or more substantially planar sheets of material, which can be made of a material such as, for example, metal, cardboard, paper, plastic, or any naturally occurring or manmade material, or any combination of the foregoing. The offset core device having the three-dimensional truss structure can be easily flattened down into a planar structure for storage or transport and then easily redeployed into the same three-dimensional truss structure. The offset core device having the three-dimensional truss structure can be used as a protective layer in packing applications and can be arranged to receive and securely hold one or more articles within it.

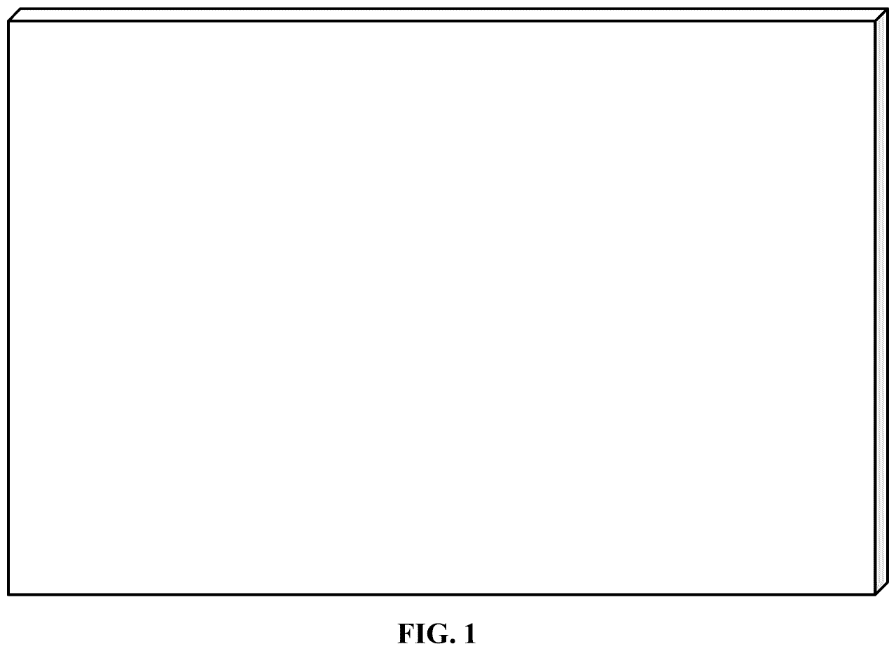

Referring to FIG. 1, a non-limiting embodiment of an offset core device 1 constructed according to the principles of the disclosure can comprise a substantially planar sheet of material, such as, for example, metal, cardboard, paper, plastic, or any naturally occurring or manmade material, or any combination of the foregoing that can be deployed or collapsed, as set forth herein.

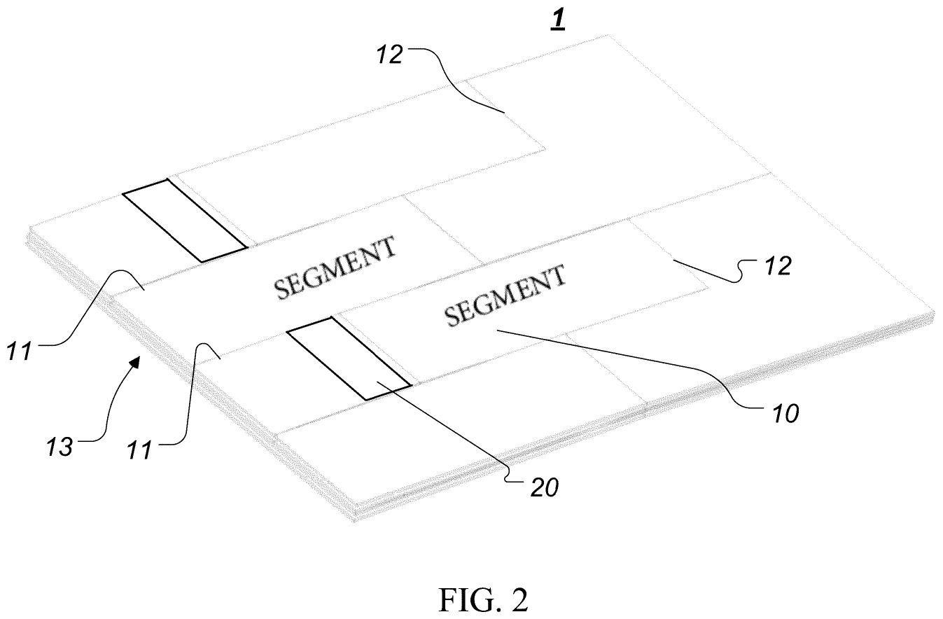

Referring to FIG. 2, the sheet of material can be cut or made to form a network of cuts 11 to form a plurality of truss segments 10. The cuts 11 can be non-synchronous (or asynchronous) or offset relative to adjacent cuts 11. Each truss segment 10 can be folded (or creased) to make a fold 13, or made with a crease (for example, living hinge) 12, with alternating segments 10 having a common crease line 12 and adjacent segments 10 having an offset crease line 12, as seen in FIG. 2—for example, similar to bricks in a brick wall. Each segment can include a segment fold (or crease) 12 that is substantially transverse to the direction of the network of cuts 11.

In certain embodiments, a truss segment crease line 12 can include a hinge or other pivot-folding mechanism.

By tuning a length of the cuts 11 and creases 12 (though leaving the overall arrangement the same), an arbitrary curvature can be prescribed to the unfolded segment 10. For example, using this modification, the flat stack can be designed to unfold (or deploy) into a cylindrical truss, a curved truss, or any other shape.

The sheet of material can be folded (or creased) to make one or more folds 13 or made with creases 12 (for example, living hinges) that are substantially transverse to the direction of the network of cuts 11 to form one or more panels of the offset core device 1. As seen, the offset core device 1 can include a plurality of panels layered atop of each other. Each panel can include a network of truss segments 10, as seen in FIG. 2. A fastener 20 such as, for example, an adhesive application, can be attached to, or made integral with, alternating truss segments 10 in each panel, as seen in FIG. 2. In certain embodiments, the fastener 20 can be attached to, or made integral with, every truss segment 10 in each panel.

The offset core device 1 can be made to have a high-strength three-dimensional offset core having a truss structure from a single substantially planar sheet by making a number of cuts 11, that can be non-synchronous (or asynchronous) or offset relative to adjacent cuts 11, and then by making a number of creases 12 (or, for example, living hinges) transverse to those cuts 11. The cuts can be made by a knife, a machine, or some other cutting method or apparatus. Alternatively, the planar sheet can be made with the network of cuts 11 and creases formed therein. The living hinges can be formed with or made as integral parts of the sheet of material, such as, for example, by hand, a machine, or some other method or apparatus.

In a non-limiting embodiment, the fastener 20, such as, for example, an adhesive, an adhesive tape, a pressure sensitive adhesive, a hook-and-loop fastener, a screw, a bolt, a pin, a clamp, or the like, can be placed onto the segments 10 created by the network of cuts 11 and living hinges 12. The fastener 20 can be applied by hand or machine. After the fastener 20 has been placed, the sheet can then be folded onto itself using a valley/mountain fold, pleat fold, z-fold, accordion fold, or some other method of folding. The fold 13 can be created by hand, by a machine, or by some other method or apparatus. Once the fastener 20 has taken hold, the sheet can be converted into its high-strength offset core three-dimensional truss structure.

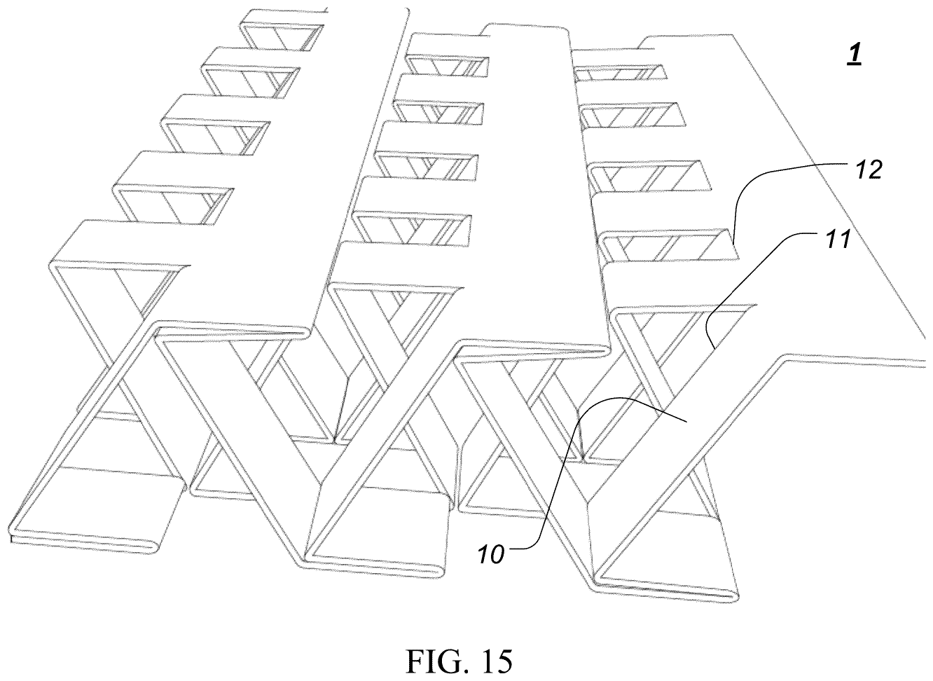

In a non-limiting embodiment of the offset core device 1, one or more optional additional planar sheets (not shown) can be affixed to either or both opposing sides (for example, the top and/or bottom sides of the offset core device 1 shown in FIG. 15) of the three-dimensional offset core truss structure to provide permanent rigidity.

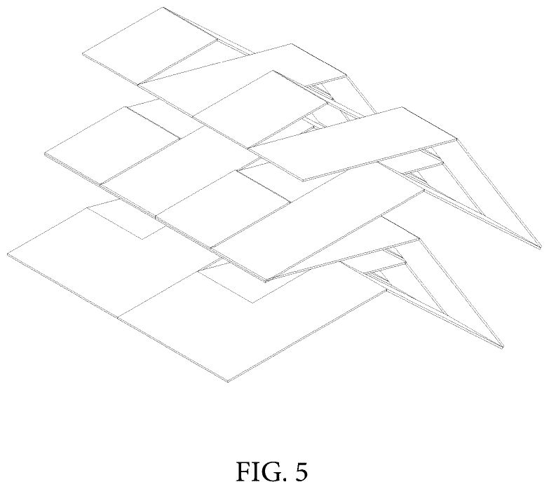

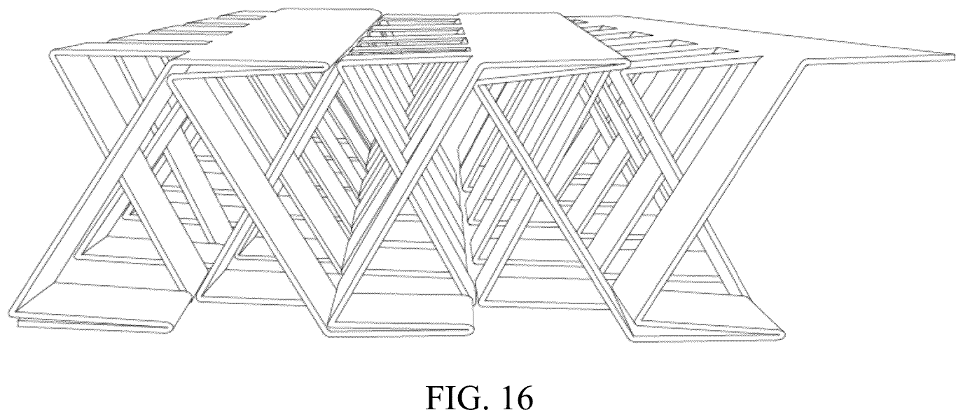

FIGS. 5 to 16 show various stages of deploying the offset core device 1 from its planar sheet configuration (for example, shown in FIG. 2) to its fully deployed 3D offset core truss structure configuration (for example, shown in FIGS. 15 and 16).

The offset core device can be collapsed by applying the opposite sequence of steps, to collapse the panels onto each other, thereby collapsing the offset core device 1 from its fully deployed 3D offset core truss structure configuration (for example, shown in FIG. 15) to the fully-collapsed planar stack configuration (for example, shown in FIG. 2).

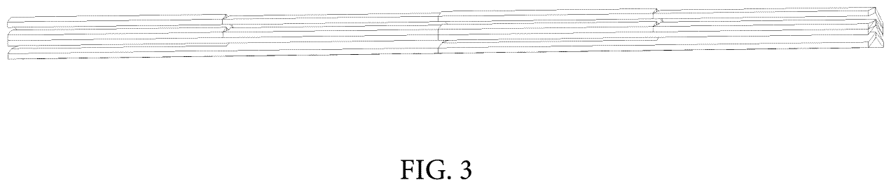

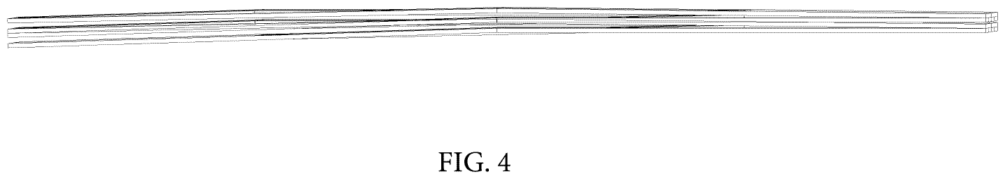

FIGS. 2-4 show various views of the offset core device 1 in collapsed configuration, including: a top left perspective view of the flattened three-dimensional truss structure after the single planar sheet has been folded and fully-collapsed to its planar stack configuration (shown in FIG. 2); a side view of the flattened offset core device after the single planar sheet has been folded and fully-collapsed to its planar stack configuration (shown in FIG. 3); and another side view of the fully-collapsed offset core device (shown in FIG. 4).

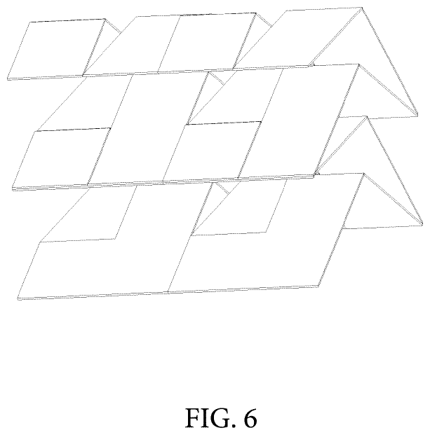

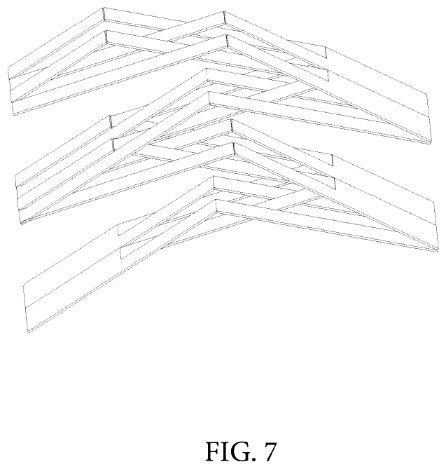

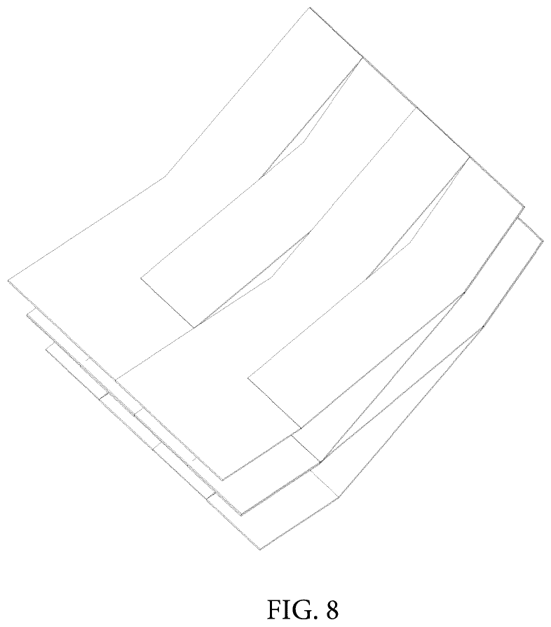

FIGS. 5-8 show various views of the offset core device 1 in a partially-deployed configuration, such as, for example, about 25% deployed, including a top left perspective view (FIG. 5), a side view (FIG. 6), another side view (FIG. 7), and a bottom view (FIG. 8).

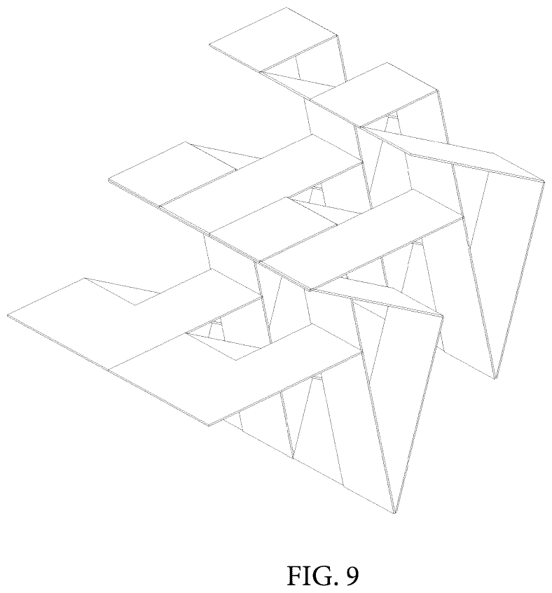

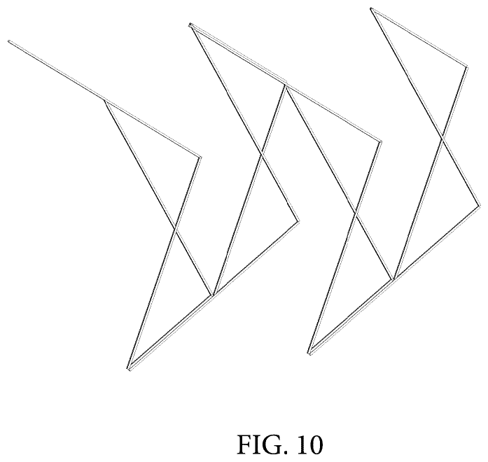

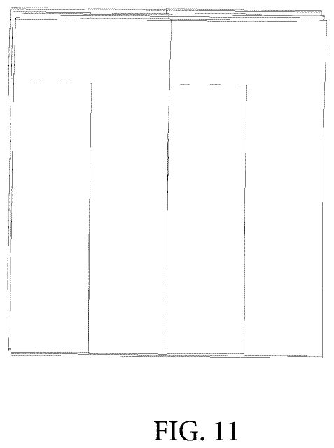

FIGS. 9-11 show various views of the offset core device 1 in a moderately-deployed configuration, such as, for example, about 50% deployed, including a top left perspective view (shown in FIG. 9), a side view (shown in FIG. 10), and another side view (shown in FIG. 11).

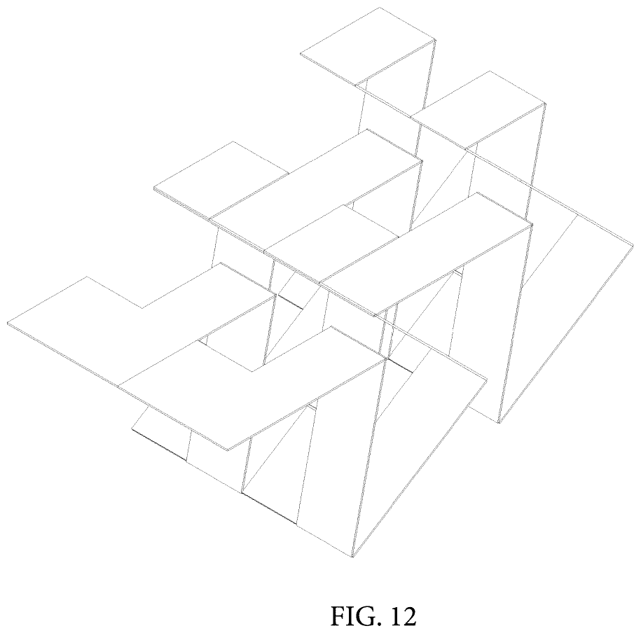

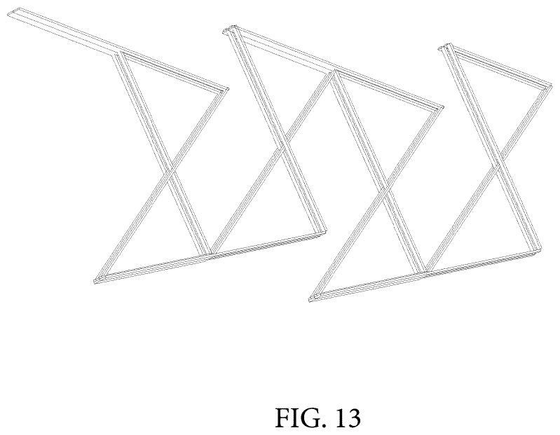

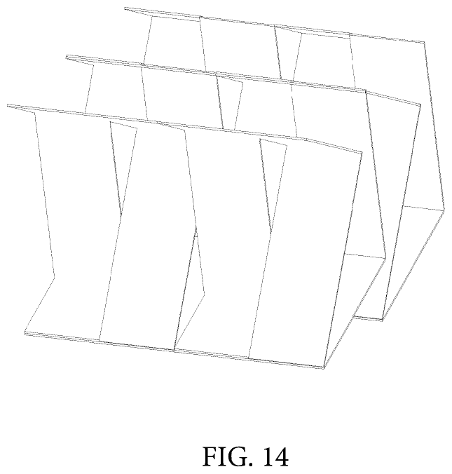

FIGS. 12-14 show various views of the offset core device 1 near-fully deployed, such as, for example, about 75% deployed, including a top left perspective view (shown in FIG. 12), a side view (shown in FIG. 13), and another side view (shown in FIG. 14).

The offset core device 1 can be made and deployed to its fully deployed configuration, as seen in FIGS. 2-16. Initially, a planar sheet of material (shown in FIG. 1) can be cut or formed with a network of cuts 11 along a first direction that is parallel to at least one edge of the planar sheet of material to form a plurality of truss segments 10, as seen in FIG. 2. Simultaneously, or at a different time, at least one crease line 12 can be formed on each truss segment 10, with each crease line 12 being transverse to the network of cuts 11. Each crease line 12 can be formed such that alternating truss segments 10 in a panel have a common crease line 12. A fastener 20 can be affixed to, or formed with, each alternating truss segment 10 of a panel, as seen in FIG. 2. In certain embodiments, an fastener 20 can be affixed to, or formed with, each truss segment of a panel.

Simultaneously, or at a different time, one or more panel lines can be formed on the planar sheet of material to form at least two panels. Each panel line can be formed along an entire width of the planar sheet of material, in a direction that is transverse to the network of cuts 11, as seen in FIG. 2.

In certain embodiments, a panel line can include a hinge or other pivot-folding mechanism.

After the planar sheet of material is provided with the network of cuts 11, segment crease lines 12, panel lines 13 and fasteners 20, adjacent panels can be folded onto each other, as seen, for example, in FIGS. 2, to a planar stack configuration (fully collapsed). A force can be applied to the planar stack to cause each truss segment 10 to buckle along a segment crease line 12. After the truss segments 10 are caused to buckle (or fold), the offset core device 1 can be spread and further pressed to convert the device 1 to its fully deployed configuration, for example, seen in FIGS. 15 and 16.

A fully deployed offset core device 1 can be converted to its planar stack configuration by compressing and collapsing the device 1, by applying an opposite sequence of steps.

In certain embodiments, the offset core device 1 can be made of a planar sheet of cardboard material. The offset core device 1 can be expanded to its fully deployed configuration and used as an insulating or protection device in applications such as, for example, packing—for example, as protective material installed between an appliance and the cardboard box within which it is packed and shipped. In various embodiments, the offset core device 1 can be made in its fully collapsed state by a corrugation-less process, including the network of parallel creases and transverse cuts, such that the formed offset core device 1 can simply be deployed to its fully deployed state. The corrugation-less process eliminates the need for folding and/or fasteners 20. According to at least one embodiment, the corrugation-less process includes configuring a three-dimensional (3D) printer (not shown) to form the deployable 3D truss structure (for example, shown in FIGS. 15 and 16) by forming the networks of segments and joints such that each segment and joint can translate from its collapsed state (for example, shown in FIG. 2) to its deployed state (for example, shown in FIGS. 15 and 16). The fully collapsed, flat structure can then be deployed to its fully deployed state, which can be one-hundred times, or greater, in size from that when it is in its collapsed state. The 3D printer can be configured with a high-strength material such as, for example, polycarbonate (PC), acrylonitrile butadiene styrene (ABS), high density poly ethylene (HDPE), metal, or the like.

Other applications for the offset core device are contemplated herein, including, for example, in building, construction, and shipping. In such applications, the offset core device can be made of the appropriate material, which can be suitable to a particular application.

According to an aspect of the disclosure, a method of manufacturing is contemplated for making an embodiment of the offset core device, including, for example, steel making, metal casting, die casting, molding, injection molding, rotational molding, extrusion blow molding, injection blow molding, casting, vacuum casting, thermoforming, compression molding, blowing, mould-blowing, pattern-moulding, tralling, cutting, fire-polishing, woodworking, carving, laminating, spinning, carbonizing, sizing, or any combination of the foregoing.

According to another aspect of the disclosure, a method of assembling is contemplated for assembling each component to make the offset core device.

The terms “a,” “an,” and “the,” as used in this disclosure, means “one or more,” unless expressly specified otherwise.

The terms “including,” “comprising,” and variations thereof, as used in this disclosure, mean “including, but not limited to,” unless expressly specified otherwise.

Although process steps, method steps, or the like, may be described in a sequential order, such processes and methods can be configured to work in alternate orders. In other words, any sequence or order of steps that may be described does not necessarily indicate a requirement that the steps be performed in that order. The steps of the processes or methods described herein can be performed in any order practical. Further, some steps can be performed simultaneously.

When a single structure or article is described herein, it will be readily apparent that more than one device or article may be used in place of a single device or article. Similarly, where more than one device or article is described herein, it will be readily apparent that a single structure or article may be used in place of the more than one structure or article. The functionality or the features of a structure or article may be alternatively embodied by one or more other structures or articles that are not explicitly described as having such functionality or feature.

While the disclosure has been described in terms of exemplary embodiments, those skilled in the art will recognize that the disclosure can be practiced with modifications in the spirit and scope of the instant disclosure. These examples given above are merely illustrative and are not meant to be an exhaustive list of all possible designs, embodiments, applications or modifications of the disclosure.

What is claimed is:

1. An offset core device formed from a planar sheet of material, the device comprising:
a network of truss segments formed in the planar sheet of material along a first direction; and
a panel line formed in the planar sheet of material along a second direction,
wherein the first direction is parallel to an edge of the planar sheet of material, and
wherein the second direction is transverse to the first direction.

2. The device of claim 1, wherein the network of truss segments comprises a network of cuts, each cut being formed in the first direction.

3. The device of claim 2, wherein each cut is made by a tool.

4. The device of claim 1, wherein the panel line comprises at least one of a crease line, a joint, and a hinge.

5. The device of claim 1, wherein the offset core device is configured to be expandable from a fully collapsed minimal thickness planar stack to a fully deployed three-dimensional offset core truss structure.

6. The device of claim 1, further comprising a plurality of fasteners, each fastener being configured to secure the offset core device in a deployed load bearing three-dimensional offset core truss structure.

7. The device of claim 6, wherein the adjacent ones of the plurality of fasteners are located on alternating truss segments.

8. The device of claim 1, wherein the plurality of fasteners comprises an adhesive application.

9. The device of claim 1, wherein the device is constructed to deploy into a curved structure.

10. The device of claim 9, wherein the curved structure is a cylindrical structure.

11. An offset core device configured to form a high-strength truss structure, the device comprising:
a plurality of panels, each panel comprising:
a network of a first plurality of truss segments and a second plurality of truss segments, each formed along a first direction;
a first joint and a second joint formed along a second direction that is perpendicular to the first direction; and
at least one cut line formed along the first direction between the first plurality of truss segments and the second plurality of truss segments,
wherein the plurality of panels are configured to deploy to a truss structure by
at least one of the first plurality of truss segments pivoting at the first joint, and
at least one of the second plurality of truss segments pivoting at the second joint,
wherein the first joint is offset from the second joint along the first direction.

12. A method of making a high-strength three-dimensional truss structure, comprising:
providing a planar sheet of material;
making a network of truss segments by forming a network of cuts asynchronous or offset relative to adjacent cuts in the planar sheet of material;
making a crease line in each truss segment of the network of truss segments;
forming a panel line transverse to the cuts in the planar sheet of material; and
applying an adhesive application to one or more truss segments in the network of truss segments.

13. The method of claim 12, further comprising:
folding the planar sheet of material onto itself along the panel line; and
folding each crease line in each truss segment of the network of truss segments to form a three-dimensional offset core truss structure.

14. The method of claim 12, wherein the cuts are made by hand, knife, or machine.

15. The method of claim 12, wherein the crease line is made by creasing each truss segment by hand or with a machine, or by utilizing laser cuts.

16. The method of claim 12, wherein the adhesive application is affixed or applied by hand or, machine.

17. The method of claim 12, wherein the adhesive application comprises an adhesive, tape, pressure sensitive adhesive.

18. The method of claim 12, wherein the crease line or panel line includes a Z fold, valley/mountain fold, pleat fold, or accordion fold.

19. The method of claim 12, wherein the device is configured to deploy as a curved structure.

20. The method of claim 13, wherein the offset core truss structure is configured deploy from a collapsed planar stack to a three-dimensional load bearing offset core truss structure configured to support a load.
